(19) United States
(12) Patent Application Publication
(10) Pub. No.: US 2003/0153381 A1
(43) Pub. Date: Aug. 14, 2003

(54) System and method of displaying a reward selection and win-or-lose result on a terminal

(75) Inventor: Warren William Slattery, Double Bay (AU)

Correspondence Address: OLIFF & BERRIDGE, PLC, P.O. BOX 19928, ALEXANDRIA, VA, 22320, US

(73) Assignee: WIN AMUSEMENT GROUP PTY LTD, Double Bay (AU)

(21) Appl. No.: 10/346,084

(22) Filed: Jan. 17, 2003

Related U.S. Application Data
(63) Continuation of application No. PCT/AU01/00882, filed on Jul. 20, 2001.

(30) Foreign Application Priority Data
Jul. 20, 2000 (AU) PQ 8886

(51) Int. Cl. A63F 13/00

(52) U.S. Cl. 463/16

(57) ABSTRACT

A method, a system and a machine for displaying a reward selection and win or lose results on a game machine including a display (1), the method including the steps of displaying a reward selection sequence on the display (1) to identify a playable reward, displaying an animated win or lose reward shot sequence on the display (1) to identify a win or lose result corresponding to the playable reward and displaying the win or lose result on the display (1).

### FIELD OF THE INVENTION

The present invention relates to a system and method of displaying a reward selection and win-or-lose result on a terminal.

The invention has been developed primarily for providing a cashless retail promotion in or near a retail outlet and will be described hereinafter with reference to that application. However, the invention is not limited to that particular field of use and is also suitable for other outlets and for the inclusion of sophisticated animation, advertising and entertainment elements.

### BACKGROUND TO THE INVENTION

A number of promotional methods are known in which retail outlets and service providers attempt to encourage customers to return to their stores. Such methods are often called ‘loyalty schemes’ and involve a number of different incentives. Some retailers use a point based rewards card, such as the ‘Fly Buys’ card, in which the consumer gains points whenever they purchase a product or service. The more they buy, the more points they get and the greater the size of the reward they can exchange their points for. Other retailers, such as supermarkets, print coupons on the backs of their receipts. These coupons usually entitle the customer to a discount of some kind at a local retail outlet or service provider.

Such prior art promotional methods are limited in their effectiveness as they do not provide the customer with a great deal of incentive to purchase more goods or services, since the rewards and coupons are so lacking in value. This lack of reward value when coupled with a lack of entertainment value, results in a fairly unsuccessful promotional technique.

Game machines are also known in a variety of forms. The most common form is the electronic poker machine which accepts cash or tokens from a user and displays a set of spinning reels to determine if the user has won any credits. If the user is successful, they can, at a push of a button, receive their credits in coins ejected from the machine. Because such machines are coin-operated, they are not suitable for retail promotions because the customer has to spend additional money to play the game. Furthermore, the user of such a machine can only win credits, not prizes or services. Because the credits won are determined in a single step when the spinning reels stop the user is denied the anticipation felt when he or she knows that they have a chance of winning a major prize. In addition, such prior art poker machines do not use entertaining animations, commercial music, sophisticated sound effects or high quality video sequences.

Any discussion of the prior art throughout the specification should in no way be considered as an admission that such prior art is widely known or forms part of common general knowledge in the field.

### BROAD DISCLOSURE OF THE INVENTION

It is an object of the present invention to overcome or substantially ameliorate at least some of these deficiencies of the prior art.

According to one aspect of the invention there is provided a method of displaying a reward selection and win-or-lose result with a terminal including a display, the method including the steps of:

(a) displaying a reward selection sequence on the display to identify a playable reward;

(b) displaying an animated win-or-lose reward shot sequence on the display to identify a win-or-lose result corresponding to the playable reward; and

(c) displaying the win-or-lose result on the display.

Preferably, the step of displaying the animated win-or-lose reward shot sequence includes the steps of:

(b1) displaying an animated character on the display;

(b2) displaying the animated character performing a task having a goal which it may succeed or fail at achieving;

(b3) identifying the win-or-lose result as a win result if the character succeeds in achieving the goal; and

(b4) identifying the win-or-lose result as a lose result if the character fails in achieving the goal.

Preferably, the task is a sport related task.

Preferably, the sport related task includes one or more of:

(i) shooting a basketball towards a basketball hoop, wherein the goal includes getting the basketball through the hoop;

(ii) hitting a golf ball towards a hole, wherein the goal includes getting the golf ball into the hole;

(iii) hitting a snookerball towards a hole, wherein the goal includes getting the snooker ball into the hole;

(iv) rolling a lawn bowls ball towards a jack, wherein the goal includes getting the ball closest to the jack;

(v) serving a tennis ball, wherein the goal includes serving an ace;

(vi) serving a table tennis ball, wherein the goal includes serving an ace;

(vii) bowling a ten pin bowling ball towards ten pins, wherein the goal includes getting a strike;

(viii) shooting at a clay pigeon target, wherein the goal includes hitting the pigeon;

(ix) marlin fishing, wherein the goal includes catching the marlin;

(x) diving off a poolside diving board, wherein the goal includes receiving a perfect score from the judges;

(xi) waterskiing over a ramp, wherein the goal includes landing safely; or

(xii) serving a volleyball, wherein the goal includes serving an ace.

Preferably, the step of displaying an animated character on the display includes the step of displaying one of six possible animated characters on the display.

Preferably, the method includes a jackpot which has a corresponding jackpot prize shot sequence.

Preferably, the jackpot prize shot sequence is an animated representation of the “Claw” game.

Preferably, the animated representation of the “Claw” game includes the steps of:

(i) displaying the six animated characters as miniature soft toys sitting in a claw container;

(ii) displaying the claw moving over the toys, dropping down and selecting one of them;

(iii) displaying the claw moving the held toy towards a receiving tray.

Preferably, the goal of the Claw game includes placing the held toy in the receiving tray.

Preferably, the six possible animated characters include six humanoid characters having bodies resembling human bodies, voices resembling human voices and faces resembling animal faces.

Preferably, the six possible animated characters are three generations of one family, namely an oldest generation, a middle generation and a youngest generation.

Preferably, the oldest generation includes characters known as Pop and Nan.

Preferably, the middle generation includes characters known as Senior and Mrs.

Preferably, the youngest generation includes characters known as Junior and Lizzie.

Preferably, the animated character is rendered using computer graphics techniques.

Preferably, the tasks are arranged into themes which determine the background and costumes of the animated characters.

Preferably, the themes include one or more of:

(i) a Carribean theme;

(ii) a Chinese theme;

(iii) an African theme;

(iv) an American theme;

(v) an English theme; and

(vi) an Italian theme.

Preferably, the terminal also includes an audio sequence player and wherein the step of displaying an animated win-or-lose reward shot sequence further includes the step of simultaneously playing an audio sequence to accompany the animated win-or-lose reward shot sequence.

Preferably, the audio sequence includes commercial music.

Preferably, the commercial music includes music commonly played on commercial radio stations.

Preferably, the step of displaying a reward selection sequence is preceded by the step of receiving a user-supplied reward selection request and wherein the step of displaying an animated win-or-lose reward shot sequence is preceded by the step of receiving a user-supplied win-or-lose play request.

Preferably, the terminal includes a game initiation button and wherein the step of receiving a user-supplied reward selection request is achieved when a user presses the game initiation button.

Preferably, the terminal includes a win-or-lose play button and wherein the step of receiving the user-supplied win-or-lose play request is achieved when a user presses the win-or-lose play button.

Preferably, the game initiation button and the win-or-lose play button are two different buttons.

Preferably, the terminal also includes an audio sequence player and wherein the step of receiving the user-supplied reward selection request is preceded by the step of playing an audible direction on the audio sequence player, requesting the user to provide the reward selection request.

Preferably, the step of receiving a user-supplied win-or-lose play request is preceded by the step of playing an audible direction on the audio sequence player, requesting the user to provide the win-or-lose play request.

Preferably, the step of displaying a reward selection sequence on the display to identify a playable reward is followed by the additional step of:

(i) playing an advertisement for the playable reward on the display.

Preferably, the step of playing the advertisement includes one or more of the following steps:

(i) displaying moving visual images on the display,

(ii) playing spoken words via the audio sequence player; and

(iii) playing music via the audio sequence player.

Preferably, the music includes commercial music.

Preferably, the commercial music includes music commonly played on commercial radio stations.

Preferably, the advertisement is stored as a compressed MPEG file and wherein the step of playing the advertisement includes the step of decompressing the compressed MPEG file and playing it on the display.

Preferably, the playable reward is one of a set of possible rewards and wherein each of the possible rewards has a corresponding reward indicia which represents the reward, and wherein the step of displaying a reward selection sequence on the display to identify the playable reward includes the steps of:

(a1) displaying a plurality of fillable shapes on the display;

(a2) displaying one or more of the reward indicia within the fillable shapes according to a predetermined selection pattern; and

(a3) displaying the indicia of the playable reward in at least one of the fillable shapes according to a predetermined win display pattern.

Preferably, the fillable shapes are arranged in one or more rows and one or more columns on the display and wherein the predetermined selection pattern includes one or more of:

(i) sequentially filling each of the rows of fillable shapes with a particular reward indicia such that at some point all of the fillable shapes in a particular row contain that particular reward indicia;

(ii) sequentially filling each of the columns of fillable shapes with a particular reward indicia such that at some point all of the fillable shapes in a particular column contain that particular reward indicia;

(iii) filling each of the fillable shapes with different reward indicia in an apparently random fashion; or

(iv) sequentially filling each diagonal array of fillable shapes with a particular reward indicia such that at some point all of the fillable shapes in a particular diagonal array contain that particular reward indicia.

Preferably, there are fifteen fillable shapes arranged in three rows and five columns on the display, the rows including a top row, a middle row and a bottom row, and wherein the predetermined selection pattern includes:

(i) sequentially filling the top and bottom rows of fillable shapes with a first reward indicia and a third reward indicia, respectively, in a left to right manner; and

(ii) simultaneously filling the middle row of fillable shapes with a second reward indicia, in a right to left manner;

such that at some point all of the fillable shapes in the top row contain the first reward indicia, all of the fillable shapes in the middle row contain the second reward indicia and all of the fillable shapes in the bottom row contain the third reward indicia.

Preferably, the predetermined selection pattern is repeated a number of times.

Preferably, the predetermined selection pattern is reversed.

Preferably, the predetermined win display pattern includes one or more of:

(a) filling all of the fillable shapes with the playable reward indicia;

(b) filling a substantial portion of the display with an enlarged fillable shape containing the playable reward indicia;

(c) filling only one of the fillable shapes with the playable reward indicia and leaving the rest of the fillable shapes unfilled;

(d) filling an entire row of the fillable shapes with the playable reward indicia; or

(e) filling an entire column of the fillable shapes with the playable reward indicia.

Preferably, the method further includes the step of:

(i) playing music during, before or between any of the steps, via the audio sequence player.

Preferably, the music is commercial music.

Preferably, the commercial music includes music commonly played on commercial radio stations.

Preferably, the terminal includes a ticket dispenser for dispensing printed tickets and wherein the step of displaying the win-or-lose result on the display is followed by the further step(s) of dispensing a printed ticket having win-or-lose result indicia printed on it.

Preferably, the printed ticket has three sections.

Preferably, the three-section printed ticket has:

(i) a second chance prize draw section including a blank name and address field;

(ii) a user-retainable prize section having win-or-lose result indicia printed on it; and

(ii) a vendor-retainable prize section having win-or-lose result indicia printed on it.

Preferably, the terminal includes a ticket receiver for receiving user supplied playing tickets and wherein the step of receiving a user-supplied reward selection request is preceded by the step of

(i) receiving a user supplied playing ticket via the ticket receiver;

(ii) confirming the validity of the playing ticket;

(iii) prompting the user to provide the reward selection request if the playing ticket is valid; and

(iv) displaying an invalid ticket message on the display if the playing ticket is invalid.

Preferably, the user supplied playing ticket includes one or more of:

(i) human readable information; and

(ii) machine readable information.

Preferably, the machine readable information includes magnetic game information stored on a magnetic strip.

Preferably, the human readable information includes written directions on how to play the game.

Preferably, the user supplied playing tickets and the printed tickets are one and the same ticket.

Preferably, the terminal is situated in or near the premised of a retail outlet which sells a plurality of products or provides a plurality of services and wherein the step of receiving the user supplied playing ticket via the ticket receiver is preceded by the steps of:

(i) selling at least one of the products or services to the user; and

(ii) providing the playing ticket to the user in response to the sale.

Preferably, the terminal further includes a controller which controls the steps taken.

Preferably, the controller is a single board computer.

Preferably, the step of displaying a reward selection sequence on the display to identify the playable reward is preceded by the step of selecting the playable reward from a plurality of possible rewards.

Preferably, the terminal stores a predetermined reward selection table storing a plurality of reward identifiers each corresponding to one of the possible rewards, along with win-or-lose indicia which indicate whether, when that reward is being played for, it will be won or lost, and wherein the step of selecting the playable reward from a plurality of possible rewards includes the steps of:

(i) incrementally stepping through the reward selection table

(ii) selecting the next reward identifiers from the reward selection table which corresponds to the current game iteration;

(iii) identifying the reward corresponding to the selected reward identifier,

(iv) making that reward the playable reward;

(iv) identifying the win-or-lose result corresponding to the selected reward identifier; and

(v) making that win-or-lose result the playable reward's corresponding win-or-lose result.

Preferably, the reward selection table may be periodically replaced or amended.

Preferably, the reward selection table can be used to predetermine the number of times each particular reward is advertised on the terminal.

Preferably, the reward selection table can be used to predetermine the number of times each particular reward is won.

Preferably, the step of displaying the win-or-lose result on the display includes, if the win-or-lose result is a win result, the steps of:

(i) displaying video footage of a fireworks display on the display; and

(ii) intermittently superimposing over at least part of that video footage indicia corresponding to the playable reward which the user has won.

Preferably, the method further includes the additional step of:

(iii) simultaneously playing an audio recording of a fireworks display via the audio sequence player.

According to another aspect of the invention there is provided a promotion terminal for displaying a reward selection and win-or-lose result, the promotion terminal including: a display for:

(a) displaying a reward selection sequence to identify a playable reward;

(b) displaying an animated win-or-lose reward shot sequence to identify a win-or-lose result corresponding to the playable reward; and

(c) displaying the win-or-lose result.

Preferably, the display displays the animated win-or-lose reward shot sequence by:

(b1) displaying an animated character;

(b2) displaying the animated character performing a task having a goal which it may succeed or fail at achieving;

(b3) identifying the win-or-lose result as a win result if the character succeeds in achieving the goal; and

(b4) identifying the win-or-lose result as a lose result if the character fails in achieving the goal.

Preferably, the task is a sport related task.

Preferably, the sport related task includes one or more of:

(i) shooting a basketball towards a basketball hoop, wherein the goal includes getting the basketball through the hoop;

(ii) hitting a golf ball towards a hole, wherein the goal includes getting the golf ball into the hole;

(iii) hitting a snooker ball towards a hole, wherein the goal includes getting the snooker ball into the hole;

(iv) rolling a lawn bowls ball towards a jack, wherein the goal includes getting the ball closest to the jack;

(v) serving a tennis ball, wherein the goal includes serving an ace;

(vi) serving a table tennis ball, wherein the goal includes serving an ace;

(vii) bowling a ten pin bowling ball towards ten pins, wherein the goal includes getting a strike;

(viii) shooting at a clay pigeon target, wherein the goal includes hitting the pigeon;

(ix) marlin fishing, wherein the goal includes catching the marlin;

(x) diving off a poolside diving board, wherein the goal includes receiving a perfect score from the judges;

(xi) waterskiing over a ramp, wherein the goal includes landing safely, or

(xii) serving a volleyball, wherein the goal includes serving an ace.

Preferably, the display displays the animated character by displaying one of six possible animated characters.

Preferably, the terminal includes a jackpot which has a corresponding jackpot prize shot sequence.

Preferably, the jackpot prize shot sequence is an animated representation of the “Claw” game.

Preferably, the animated representation of the “Claw” game includes the steps of:

(i) displaying the six animated characters as miniature soft toys sitting in a claw container,

(ii) displaying the claw moving over the toys, dropping down and selecting one of them;

(iii) displaying the claw moving the held toy towards a receiving tray.

Preferably, the goal of the Claw game includes placing the held toy in the receiving tray.

Preferably, the six possible animated characters include six humanoid characters having bodies resembling human bodies, voices resembling human voices and faces resembling animal faces.

Preferably, the six possible animated characters are three generations of one family, namely an oldest generation, a middle generation and a youngest generation.

Preferably, the oldest generation includes characters known as Pop and Nan.

Preferably, the middle generation includes characters known as Senior and Mrs.

Preferably, the youngest generation includes characters known as Junior and Lizzie.

Preferably, the animated character is rendered using computer graphics techniques.

Preferably, the tasks are arranged into themes which determine the background and costumes of the animated characters.

Preferably, the themes include one or more of:

(i) a Carribean theme;

(ii) a Chinese theme;

(iii) an African theme;

(iv) an American theme;

(v) an English theme; and

(vi) an Italian theme.

Preferably, the terminal further includes an audio sequence player and wherein the audio sequence player simultaneously plays an audio sequence to accompany the animated win-or-lose reward shot sequence.

Preferably, the audio sequence includes commercial music.

Preferably, the commercial music includes music commonly played on commercial radio stations.

Preferably, the display displays the reward selection sequence after the machine receives a user-supplied reward selection request and wherein the display displays an animated win-or-lose reward shot sequence after the machine receives a user-supplied win-or-lose play request.

Preferably, the terminal includes a game initiation button and wherein the machine receives the user-supplied reward selection request when a user presses the game initiation button.

Preferably, the terminal includes a win-or-lose play button and wherein the machine receives the user-supplied win-or-lose play request when a user presses the win-or-lose play button.

Preferably, the game initiation button and the win-or-lose play button are two different buttons.

Preferably, the terminal also includes an audio sequence player and wherein the audio sequence player plays an audible direction, requesting the user to provide the reward selection request before the machine receives the user-supplied reward selection request.

Preferably, the audio sequence player plays an audible direction, requesting the user to provide the win-or-lose play request before the machine receives the user-supplied reward selection request.

Preferably, after the display displays the reward selection sequence to identify a playable reward it:

(i) displays an advertisement for the playable reward.

Preferably, the machine plays the advertisement by:

(i) displaying moving visual images on the display;

(ii) playing spoken words via the audio sequence player; and

(iii) playing music via the audio sequence player.

Preferably, the music includes commercial music.

Preferably, the commercial music includes music commonly played on commercial radio stations.

Preferably, the advertisement is stored as a compressed MPEG file and wherein the machine plays the advertisement by decompressing the compressed MPEG file and playing it on the display.

Preferably, the playable reward is one of a set of possible rewards and wherein each of the possible rewards has a corresponding reward indicia which represents the reward, and wherein the display displays the reward selection sequence to identify the playable reward by:

(a1) displaying a plurality of fillable shapes;

(a2) displaying one or more of the reward indicia within the fillable shapes according to a predetermined selection pattern; and

(a3) displaying the indicia of the playable reward in at least one of the fillable shapes according to a predetermined win display pattern.

Preferably, the fillable shapes are arranged in one or more rows and one or more columns on the display and wherein the predetermined selection pattern includes one or more of:

(i) sequentially filling each of the rows of fillable shapes with a particular reward indicia such that at some point all of the fillable shapes in a particular row contain that particular reward indicia;

(ii) sequentially filling each of the columns of fillable shapes with a particular reward indicia such that at some point all of the fillable shapes in a particular column contain that particular reward indicia;

(iii) filling each of the fillable shapes with different reward indicia in an apparently random fashion; or

(iv) sequentially filling each diagonal array of fillable shapes with a particular reward indicia such that at some point all of the fillable shapes in a particular diagonal array contain that particular reward indicia.

Preferably, there are fifteen fillable shapes arranged in three rows and five columns on the display, the rows including a top row, a middle row and a bottom row, and wherein the predetermined selection pattern includes:

(i) sequentially filling the top and bottom rows of fillable shapes with a first reward indicia and a third reward indicia, respectively, in a left to right manner; and

(ii) simultaneously filling the middle row of fillable shapes with a second reward indicia, in a right to left manner;

such that at some point all of the fillable shapes in the top row contain the first reward indicia, all of the fillable shapes in the middle row contain the second reward indicia and all of the fillable shapes in the bottom row contain the third reward indicia.

Preferably, the predetermined selection pattern is repeated a number of times.

Preferably, the predetermined selection pattern is reversed.

Preferably, the predetermined win display pattern includes one or more of:

(a) filling all of the fillable shapes with the playable reward indicia;

(b) filling a substantial portion of the display with an enlarged fillable shape containing the playable reward indicia;

(c) filling only one of the fillable shapes with the playable reward indicia and leaving the rest of the fillable shapes unfilled;

(d) filling an entire row of the fillable shapes with the playable reward indicia; or

(e) filling an entire column of the fillable shapes with the playable reward indicia.

Preferably, the audio sequence player:

(i) plays music during, before or after the game.

Preferably, the music is commercial music.

Preferably, the commercial music includes music commonly played on commercial radio stations.

Preferably, the terminal includes a ticket dispenser for dispensing printed tickets and wherein after the display displays the win-or-lose result, the ticket dispenser dispenses a printed ticket having win-or-lose result indicia printed on it.

Preferably, the printed ticket has three sections.

Preferably, the three-section printed ticket has:

(i) a second chance prize draw section including a blank name and address field;

(ii) a user-retainable prize section having win-or-lose result indicia printed on it; and

(ii) a vendor-retainable prize section having win-or-lose result indicia printed on it.

Preferably, the terminal further includes a ticket receiver for receiving user supplied playing tickets and wherein before the terminal receives the user-supplied reward selection request:

(i) the ticket receiver receives the user supplied playing ticket via the ticket receiver;

(ii) the machine confirms the validity of the playing ticket;

(iii) the machine prompts the user to provide the reward selection request if the playing ticket is valid; and

(iv) the display displays an invalid ticket message if the playing ticket is invalid.

Preferably, the user supplied playing ticket includes one or more of:

(i) human readable information; and

(ii) machine readable information.

Preferably, the machine readable information includes magnetic game information stored on a magnetic strip.

Preferably, the human readable information includes written directions on how to play the game.

Preferably, the user supplied playing tickets and the printed tickets are one and the same ticket.

Preferably, the terminal is situated in or near the premised of a retail outlet which sells a plurality of products or provides a plurality of services and wherein before the ticket receiver receives the user supplied playing ticket, the retail outlet:

(i) sells at least one of the products or services to the user; and

(ii) provides the playing ticket to the user in response to the sale.

Preferably, the terminal further includes a controller which controls the steps taken.

Preferably, the controller is a single board computer.

Preferably, the controller selects the playable reward from a plurality of possible rewards before the display displays the reward selection sequence to identify the playable reward.

Preferably, the terminal stores a predetermined reward selection table storing a plurality of reward identifiers each corresponding to one of the possible rewards, along with win-or-lose indicia which indicate whether, when that reward is being played for, it will be won or lost, and wherein the step of selecting the playable reward from a plurality of possible rewards includes the steps of:

(i) incrementally stepping through the reward selection table

(ii) selecting the next reward identifiers from the reward selection table which corresponds to the current game iteration;

(iii) identifying the reward corresponding to the selected reward identifier;

(iv) making that reward the playable reward;

(iv) identifying the win-or-lose result corresponding to the selected reward identifier; and

(v) making that win-or-lose result the playable reward's corresponding win-or-lose result.

Preferably, the reward selection table may be periodically replaced or amended.

Preferably, the reward selection table can be used to predetermine the number of times each particular reward is advertised on the terminal.

Preferably, the reward selection table can be used to predetermine the number of times each particular reward is won.

Preferably, if the win-or-lose result is a win result, the display displays the win-or-lose result by:

(iii) displaying video footage of a fireworks display; and

(iv) intermittently superimposing over at least part of that video footage indicia corresponding to the playable reward which the user has won.

Preferably, the audio sequence player:

(iii) simultaneously plays an audio recording of a fireworks display.

According to a third aspect of the invention there is provided a method for allowing a participant in a promotion to determine if he, she or it has been awarded a prize, the method including:

issuing the participant with an information carrier containing promotion information;

providing a promotion terminal having a housing, an input device mounted to the housing, and a processor mounted to-the housing for driving a display;

interacting the information carrier with the input device such that the processor is provided access to the promotion information; and

driving the display with the processor, in response to the information, to inform the participant whether or not he, she or it has been awarded the prize.

Preferably, the promotion is provided by a promoter for a retailer having at least one point of sale (POS), and the method includes the step of issuing the information carrier to the participant at the POS.

Preferably also, the information carrier is a card and the promotion information is printed on the card in machine readable form.

In a preferred form, the terminal is disposed near the POS and the input device includes a card reader, the method including the step of the participant inserting the card into the reader.

According to a fourth aspect of the invention there is provided a promotion terminal for allowing a participant in a promotion to determine if he, she or it has been awarded a prize, wherein the participant has been issued with an information carrier containing promotion information, the terminal including:

a housing;

a display mounted to the housing;

an input device mounted to the housing for interacting with the information carrier to determine the promotion information; and

a processor mounted to the housing and being responsive to the promotion information for driving the display to inform the participant whether or not he, she or it has been awarded the prize.

Preferably, the promotion information includes data that is indicative of one or more of the following:

whether a prize is to be awarded to the participant;

a categorisation of the prize;

an identification number for the promotion;

a verification number for the carrier; and

a ticket number for the carrier.

According to a fifth aspect of the invention there is provided an information carrier for issuing to a participant in a promotion, the promotion including the award of a plurality of prizes and the carrier including:

a substrate;

promotion information carried by the substrate in a first region for allowing the participant to determine if he, she or it has been awarded one of the prizes, the determination occurring through interacting the carrier with a terminal;

prize information carried by the substrate in a respective plurality of second regions for displaying the nature of corresponding prizes; and

a verification device for obscuring from view the prize information.

Preferably, the promotion information is machine readable and the prize information is human viewable. More preferably, the verification device is selectively adjusted by the participant to allow viewing of the prize information contained within one or more of the respective second regions. Even more preferably, the terminal provides the participant with an indication as to which one or more of the second regions are to be viewed and the carrier is voided if the verification device is adjusted to allow viewing of any other of the second regions.

Preferably also, the promotion information contains data indicative of the second region or regions that are viewable without voiding the carrier.

### BRIEF DESCRIPTION OF THE DRAWINGS

Preferred embodiments of the invention will now be described, by way of example only, with reference to the accompanying drawings in which:

FIG. 1a is a perspective view of a game machine according to the invention;

FIG. 1b is a front view of the game machine;

FIG. 1c is a top view of the game machine;

FIG. 1d is a perspective view of the game machine with its door in an open position;

FIG. 1e is a front and rear view of a playable ticket.

FIGS. 2a and 2b are two parts of a flow chart illustrating the steps involved in the method of the invention;

FIG. 3 is a screen dump of an initial screen;

FIG. 4a is a screen dump of an invalid ticket message;

FIG. 4b is a screen dump of a reward selection request prompt;

FIG. 5 is a screen dump of a game initiation message;

FIG. 6 is a block diagram of a reward selection table;

FIGS. 7a and 7b are two parts of a flow chart of a reward selection sequence according to the invention;

FIG. 8 is a screen dump of a winning display pattern;

FIG. 9 is a screen dump of an advertisement for a playable reward;

FIG. 10 is a screen dump of a win or lose play request prompt;

FIGS. 11a and 11b are screen dumps of win-or-lose reward shot sequences;

FIG. 12 is a screen dump of a lose result message;

FIG. 13 is a screen dump of a win result message;

FIG. 14 is a front view of a three part ticket;

FIGS. 15a and b are screen dumps of jackpot entry prompts according to the invention;

FIG. 16 is a view of the front face of a promotion card according to a further embodiment of the invention; and

FIG. 17 is a view of the rear face of the card of FIG. 16;

FIG. 18 is a schematic representation of the card of FIG. 16 illustrating the major regions of the front face; and

FIG. 19 is a schematic representation of the card of FIG. 17 illustrating the major regions of the rear face.

### DETAILED DESCRIPTION OF THE PREFERRED EMBODIMENTS

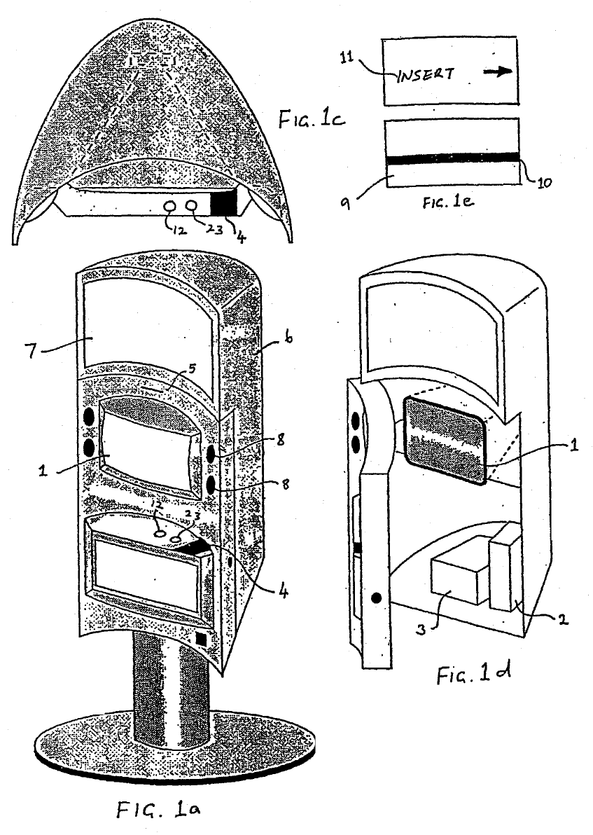

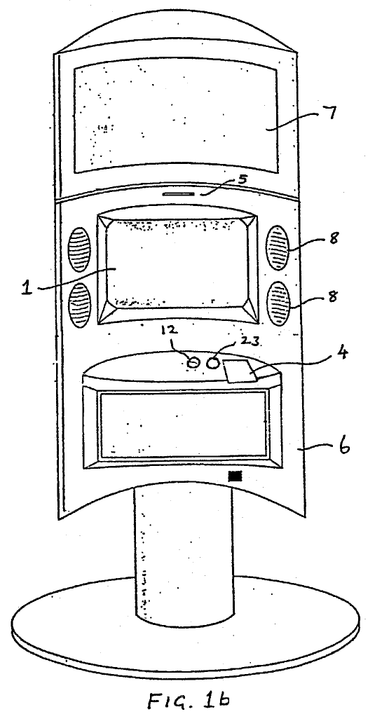

Referring to the drawings, FIGS. 1a to 1d show a terminal including a display 1, an audio sequence player 2, a controller 3, a ticket receiver 4 and a ticket dispenser 5. Additional features of the preferred terminal include an aesthetically designed casing 6, a light box 7 for displaying fixed advertisements and a plurality of speakers 8.

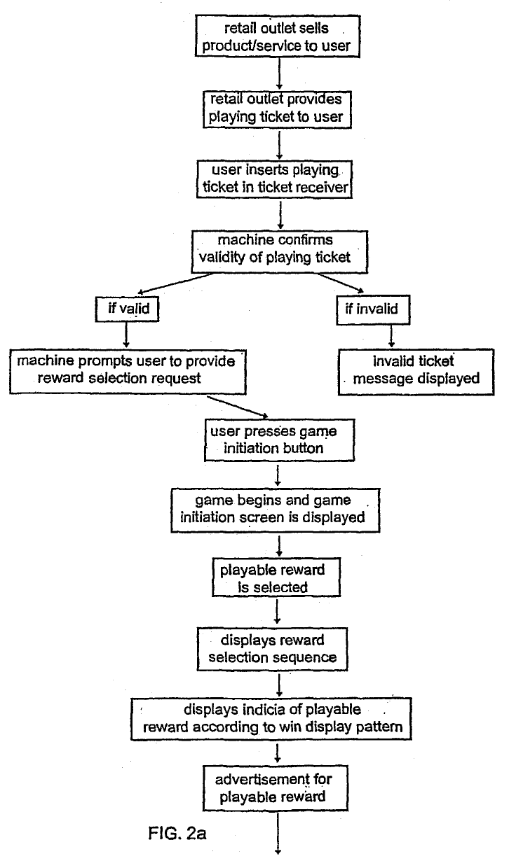

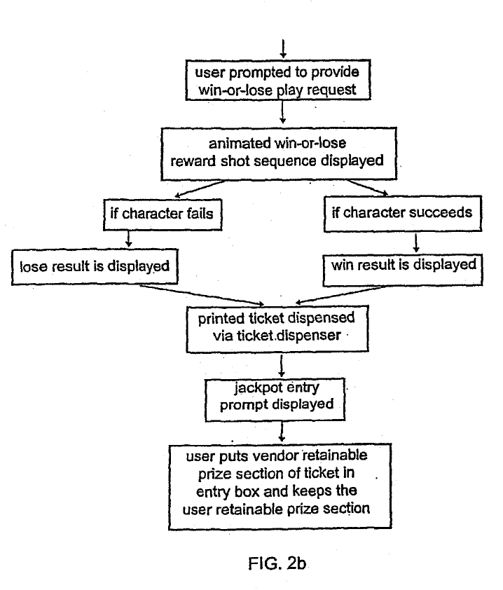

FIG. 2 shows a flow chart illustrating the steps involved in using the terminal. Those steps will now be described using FIG. 2 as a basis, and referring to the remaining figures to illustrate specific details.

The terminal is situated in or near the premises of a retail outlet which sells a variety of products, or a service provider which provides a variety of services.

To use the game, the retail outlet sells a product or service to the user. The retail outlet then provides a playing ticket 9 to the user.

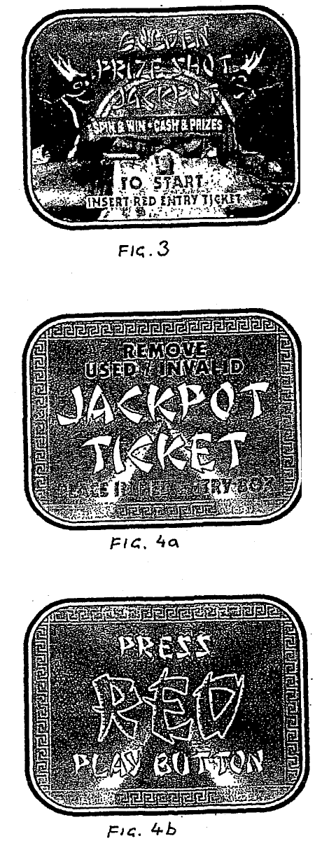

When the terminal is not being used an initial screen, shown in FIG. 3, is displayed.

The user then takes the playing ticket and inserts it in the ticket receiver. When the terminal receives the user supplied playing ticket 9 via the ticket receiver, it confirms the validity of the playing ticket.

The playing ticket 9, shown in FIG. 1e, has a magnetic strip 10 on one side and written directions 11 on the other side. The magnetic strip stores magnetic game information which is machine readable. The written directions provide the user with directions as to how to play the game and are written in any human readable language.

The terminal confirms the validity of the playing ticket by reading the magnetic strip and comparing the magnetic game information with predetermined ticket validity information.

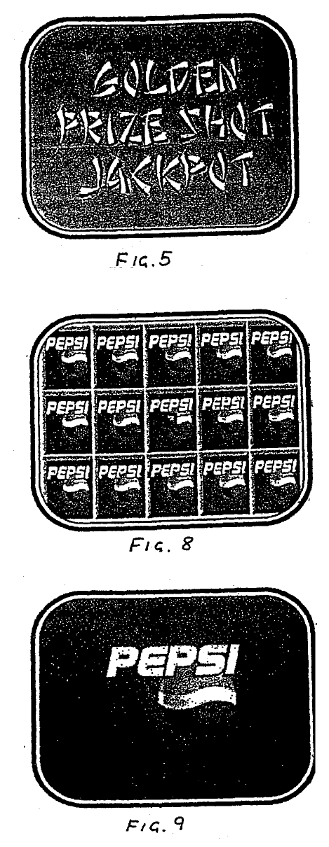

If the playing ticket is invalid, an invalid ticket message, shown in FIG. 4a, is presented on the display.

If, however, the playing ticket is valid the terminal prompts the user to provide a reward selection request. This prompt takes the form of both a prompt message appearing on the display, as shown in FIG. 4b, and an audible direction. The audible direction is played on the audio sequence player 2 and requests the user to provide a reward selection request.

The user then presses a game initiation button 12 which, in this embodiment is a red play button. As such, the game receives the user supplied reward selection request.

The game then begins and a game initiation screen, shown in FIG. 5, is presented on the display.

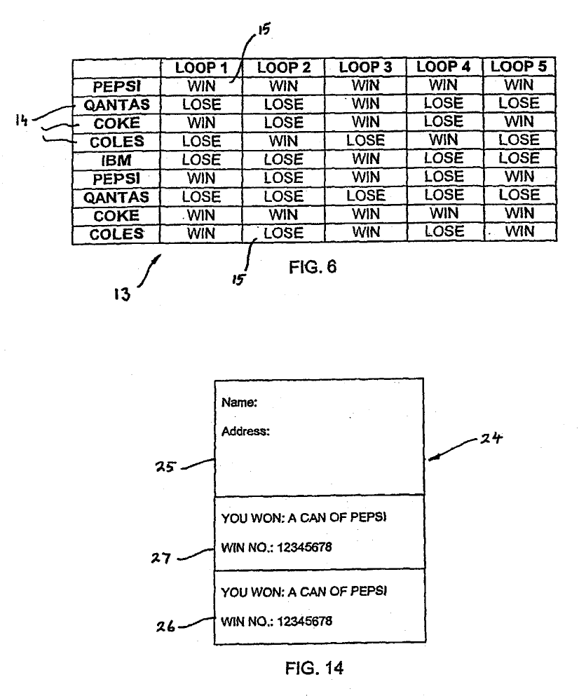

The game then selects a playable reward from a number of possible rewards. Possible rewards include cash prizes, products, services and the like. The possible rewards are arranged in a reward selection table 13, shown in FIG. 6, which includes all of the rewards 14 that can be won, along with win-or-lose indicia 15 which indicate whether, when that reward is being played for, it will be won or lost. For example, there may be 200 different rewards comprising cash prizes of a variety of values, product prizes ranging from supermarket items like soft drink cans to major prizes such as house and land packages, as well as service prizes which could range from a single free car service to a lifetime supply of car services. Each of these possible rewards are arranged in the reward selection table illustrated in FIG. 6. The rewards are listed down the left hand column of the reward selection table, the top row of the table shows the display iteration or loop, and the entries within the table contain the win-or-lose indicia 15 corresponding to the particular reward and particular loop.

For example, in an embodiment where one of the reward suppliers is, say, a soft drink manufacturer, the product to be won is a can of soft drink from that manufacturer. Due to the type of product involved, the manufacturer allows a can of soft drink to be won each time a game is played. That is, each of the win-or-lose indicia corresponding to the manufacturer's reward would be win results, as shown by way of example in the second row of the table. On the other hand, for a reward supplier such as a travel group and the reward being an around the world trip for two valued at $10,000, it is usual that there will be a considerably lesser number of prizes awarded. In this embodiment, there is only one such prize, even though the prize is played for 400 times. In that case, 399 of the win-or-lose indicia corresponding to that travel groups prize are lose results, and only one is a win result.

Each time the game is played the terminal steps through the reward selection table, proceeding down the first column, then the second column, and so on, to determine which reward will be played for, and whether that reward will be won or lost. In this way, the suppliers of the reward not only control the number of times their products are advertised on the game machine, but are also able to predetermine how many times their particular reward is won.

In one embodiment of the invention, the reward selection table is periodically replaced, once the game machine has gone through a predetermined number of loops or iterations. In this way, the rewards being played for, and won, can be varied from time to time, as required. In some embodiments, the replacement is on a 13 week cycle.

Returning to the flow chart of FIG. 2, once the playable reward has been selected from the set of possible rewards, the game machine then displays a reward selection sequence on the display to identify that playable reward. Each of the possible rewards has a corresponding reward indicia which represents that reward. For example if the reward were a can of soft drink, its corresponding reward indicia would be the trade mark and logo of the soft drink manufacturer. Similarly, where the reward is a computer, its corresponding reward indicia is the computer manufacturer's trade mark.

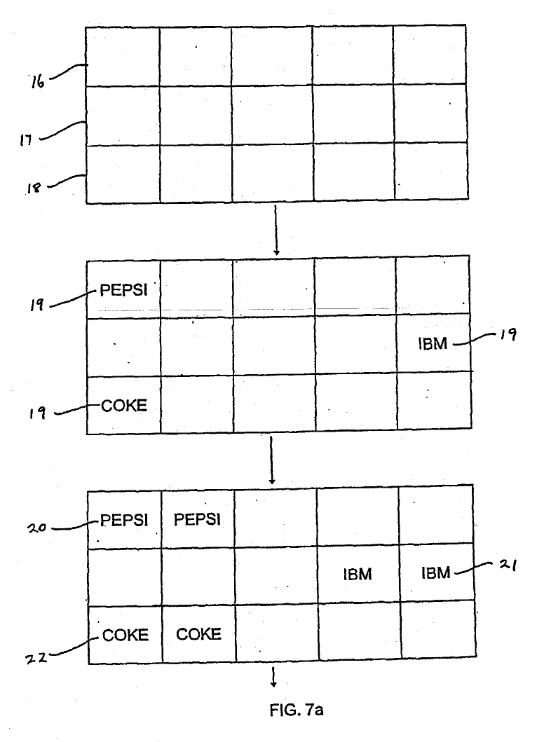

The step of displaying the reward selection sequence involves first displaying 15 fillable squares arranged in three rows and five columns on the display. As shown in FIGS. 7a and 7b those rows include a top row 16, a middle row 17 and a bottom row 18.

The game machine then selectively and sequentially displays reward indicia 19 in the fillable squares according to a predetermined selection pattern. In the embodiment shown in FIG. 7, the predetermined selection pattern involves sequentially and sequentially filling the top and bottom rows of the fillable squares with first and third reward indicia 20 and 22 in a left to right manner. The selection pattern also involves simultaneously filling the middle row of fillable squares with a second reward indicia 21, in a right to left manner. As seen at the bottom of FIG. 7b, once the selection pattern has gone through five incremental steps, all of the fillable squares in the top row contain the first reward indicia 20, all of the fillable squares in the middle row contain the second reward indicia 21, and all of the fillable squares in the bottom row contain the third reward indicia 22. Although not illustrated, the predetermined selection pattern then involves emptying and refilling each of the fillable squares a number of times in both forward and reverse directions.

A number of alternative embodiments of selection sequence are envisaged, including but not limited to using a different number of fillable squares, using other shapes instead of squares, sequentially filling the columns of the fillable shapes with a particular reward indicia, rather than filling the rows, filling individual fillable shapes with different reward indicia in an apparent random fashion, filling diagonal arrangements of fillable shapes with a particular reward indicia, and the like.

The next step of displaying the reward selection sequence involves displaying the indicia of the playable reward in at least one of the fillable squares according to a predetermined win display pattern. In the embodiment illustrated in FIG. 8, the predetermined win display pattern involves filling all of the fillable squares with the playable reward indicia, which, in this case is the Pepsi trademark and logo.

A number of alternative embodiments of win display patterns are also envisaged, including but not limited to patterns which involve filling a substantial portion of the display with an enlarged fillable square (or other shape) containing the playable reward indicia, filling only one of the fillable shapes with the playable reward indicia and leaving the rest of the fillable shapes unfilled, filling an entire row of the fillable shapes with the playable reward indicia, filling an entire column of the fillable shapes with the playable reward indicia, and the like.

Returning to the flow chart of FIG. 2, once the terminal has displayed the reward selection sequence on the display in order to identify the playable reward, it then plays and advertisement for that playable reward on the display. The advertisement is stored as a compressed MPEG and is played by decompressing that file and playing it on the display. A number of different types of advertisements are envisaged, preferably being advertisements having moving visual images, spoken words being played by the audio sequence player and high quality commercial music being played simultaneously. Because the controller shown in FIG. 1d is a single board computer, it is able to quickly decompress and play the MPEG files so that they appear to the user like television quality commercials. Although the preferred embodiment involves a 10 second television commercial grab, a number of other lengths and formats of advertisements are envisaged. Because a television style commercial is played on the display, the reward supplier is able to advertise their product in a high quality manner, without the cost of broadcasting it on television. The user is also entertained and enthralled by the advertisement, further enhancing the impact which it has. Because the game machine plays high quality commercial music this adds to the interest factor, and increases the impact of the advertisement.

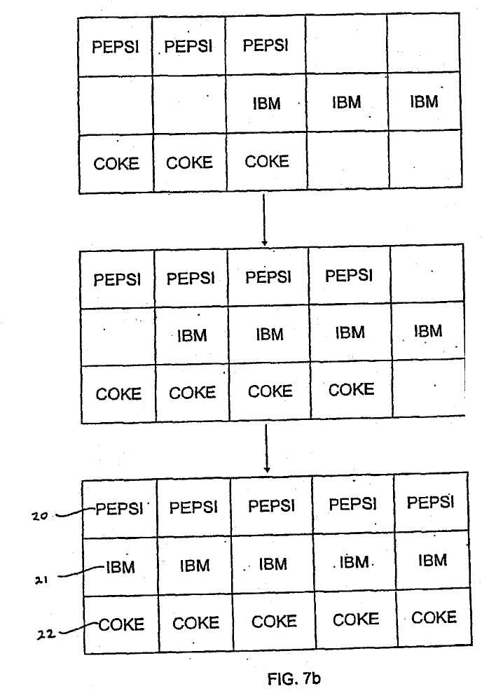

FIG. 9 illustrates a screen dump of one portion of an advertisement for a drink manufacturer.

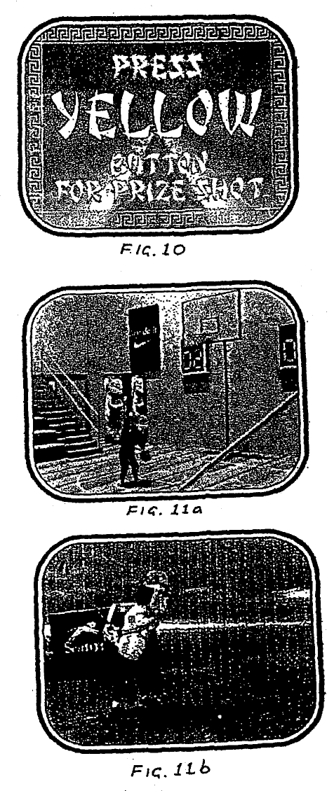

Returning to FIG. 2, once the advertisement has been displayed, the user is then prompted to provide a win-or-lose play request. This prompt involves both a visible message, as shown in FIG. 10, and an audible direction played on the audio sequence player, requesting the user to provide the win-or-lose play request. In this embodiment the game machine receives the user supplied win-or-lose play request when the user presses a win-or-lose play button 23 (see FIG. 1b), which, in this case is a yellow button on the game machine.

Once the user has provided the win-or-lose play request, the game machine displays an animated win-or-lose reward shot sequence on the display to identify the win-or-lose result which corresponds to the playable reward. As mentioned earlier, the win-or-lose result is determined according to the reward selection table. Three example embodiments of the animated win-or-lose reward shot sequence are shown in FIGS. 11a and 11b. The sequence involves displaying one of six possible animated characters on the display using computer graphics techniques. In this embodiment, the six possible animated characters are humanoid characters having bodies resembling human bodies, voices resembling human voices and faces resembling animal faces. They are three generations of one family. One generation includes the characters Nan and Pop. Another generation includes Senior and Missus and the third generation includes the characters Lizzie and Junior.

The animated win-or-lose award shot sequence involves displaying one of the animated characters performing a task which has a goal which the character either succeeds or fails to achieve. For example, junior is shown in FIG. 11a shooting a basketball towards a basketball hoop. The goal in that reward shot sequence is getting the basketball through the hoop. In FIG. 11b, Pop is shown hitting a golf ball towards a hole. In that case, the goal is getting the golf ball into the hole. A number of different reward shot sequences are envisaged, some of which are sport related tasks. In one embodiment, the reward shot sequences are arranged into themes such as Chinese, Caribbean, African, American, English and Italian themes. In each of the themes, each of the six characters have different prize shot sequences. For example, in the Chinese theme, the six characters are on holidays in China. Pop's sport related task is to hit a golf ball towards a hole (see FIG. 11b), the goal is to get the ball in the hole. Senior's task is to strike a billiard ball with a cue, the goal being to get one or more of the balls into the pocket. Junior's task is to throw a basketball towards a hoop (see FIG. 11a), the goal being to get the basketball through the hoop. Nan's task is to play bowls, the goal being to get closest to the jack. Missus' task is to serve a tennis ball, the goal being to ace her opponent. Lizzie's task is to bowl a ten pin bowling ball, the goal being to get a strike.

Similarly, in the Caribbean theme, Pop's task is to shoot at a clay pigeon, the goal being to hit the pigeon. Nan's task is to serve a table tennis ball, the goal being to serve an ace. Senior's task is to go marlin fishing, the goal being to catch a marlin. Missus' task is to dive off a pool side diving board, the goal being to score a perfect ten from the judges. Junior's task is to waterski over a ramp, the goal being to land safely. Lizzie's task is to serve a beach volley ball, the goal being to serve an ace.

In the $500,000 jackpot prize shot sequence an animated representation of the “Claw” game is shown. In that sequence, the six animated characters appear as miniature soft toy sitting in the claw container. Once the user provides the win-or-lose play request, the claw moves over the toys, drops down and selects one of them. The goal in this sequence is to get the toy into the side tray. A lose result is achieved if the toy falls out of the claw before getting to the tray.

A large variety of alternative reward shot sequences are also envisaged.

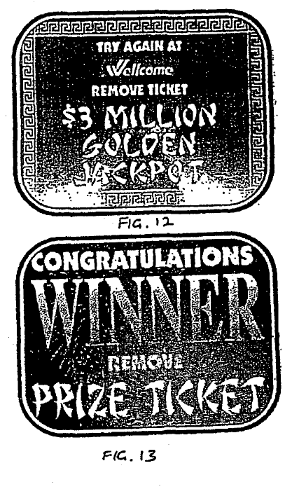

Returning to FIG. 2, if the character fails in achieving its goal a lose result, such as that shown in FIG. 12 is displayed. If, on the other hand, the character succeeds in achieving its goal a win result, such as that shown in FIG. 13 is displayed. The win result shown includes video footage of fireworks going off, accompanied by fireworks sound effects being played through the audio sequencer.

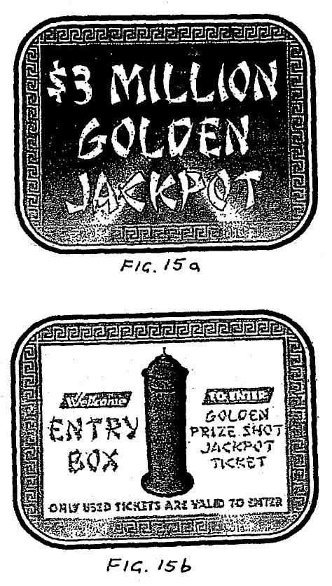

Returning to FIG. 2, once the win-or-lose result has been displayed on the display, the game machine dispenses a printed ticket via the ticket dispenser. As shown in FIG. 14, the ticket is a three section printed ticket 24 including a second chance prize draw section 25, a user retainable prize section 26 and a vendor retainable prize section 27. Once the user has received the ticket he or she then fills in their name and address in the blank name and address field in the second chance prize draw section. The ticket is then deposited in an entry box provided. As shown in FIGS. 15a and 15b, once the ticket has been dispensed, a visual jackpot entry prompt is displayed on the screen to instruct the user as to how to deal with the three part ticket. At the same time, an audible direction is played through the audio sequencer. If the player has won a prize, they then put the vendor retainable prize section in the entry box and keep the user retainable prize section as proof of their win.

In this way, reward providers are able to advertise their products in an entertaining way that allows users to both enjoy the advertisements displayed and the animated win or lose reward shot sequence whilst anticipating the possibility of winning one of a number of possible rewards.

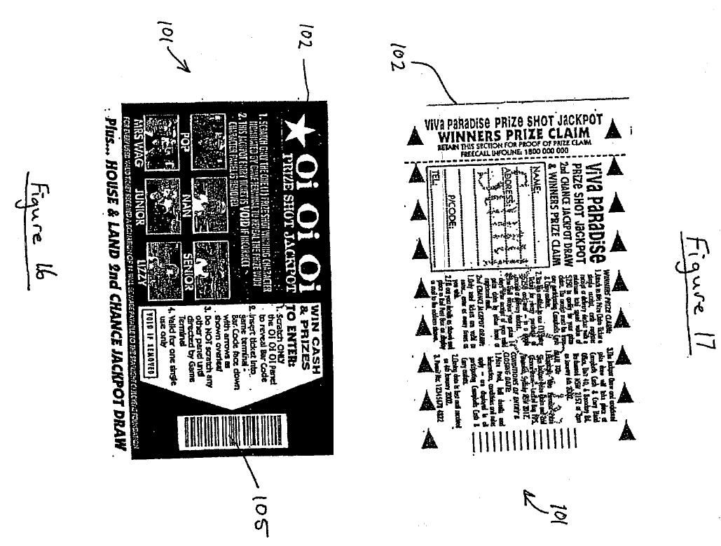

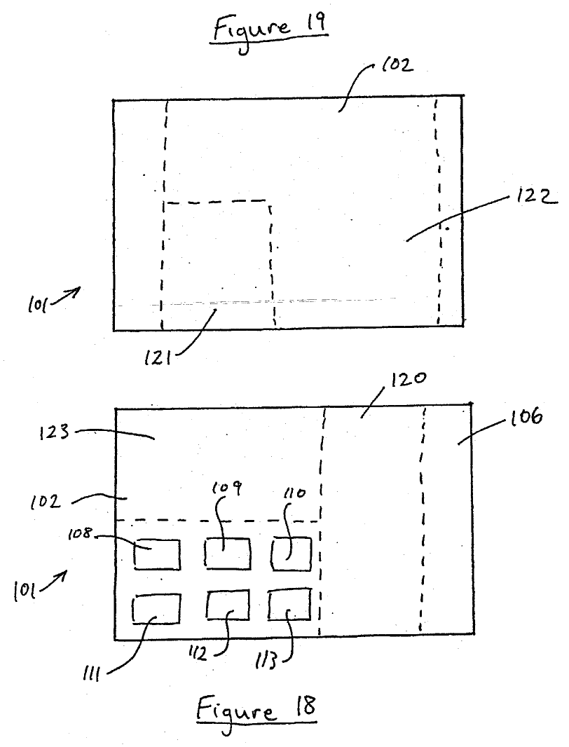

Reference is now made to FIGS. 16 to 19 which illustrate an alternative embodiment of the invention. More particularly, there is illustrated an information carrier in the form of a rectangular printed cardboard card 101 for issuing to a participant in a promotion. The promotion includes the award of a plurality of prizes (not shown) and the card includes a cardboard substrate 102 having first and second faces 103 and 104. Promotion information in the form of a printed bar code 105 is carried by substrate 102 in a first region 106 for allowing the participant to determine if he, she or it has been awarded one of the prizes. The determination occurs through interacting card 101 with a terminal, such as that illustrated in FIG. 1. Prize information is carried by substrate 102 in an array of six spaced apart second regions 108, 109, 110, 111, 112 and 113 for displaying the nature of corresponding prizes. This prize information is not, at least initially, viewable by the participant, as will be described below. A verification device, in the form of six separate opaque latex panels, obscures from view the prize information by extending over respective regions 108, 109, 110, 111, 112 and 113.

Bar code 105 includes data indicative of:

whether a prize is to be awarded to the participant;

a categorisation of the prize. That is, the brand or product name and quantity of product;

an identification number for the promotion;

the advertiser associated with the prize;

a verification number for the carrier; and

a ticket number for the carrier.

That is, the terminal does not, for this embodiment determine whether or not a prize is to be awarded to the participant. Nor does it determine the nature or extend of the prize that is awarded. Rather, those determinations are made earlier and are hard coded into the card at the time of printing. Accordingly, for any given promotion, the desired numbers of cards are produced with a predetermined number of those cards being designated as awarding a predetermined number of known prizes. In this way the promoter is able to accurately determine the maximum liability of the prize give away and to fix the odds so as to not offend against gaming regulations. That is, there is no randomness in the awarding of a prize once the card has been issued. The uncertainty involved is the order in which the cards are distributed to participants in the promotion.

A given promotion will involve:

1. A promoter who is arranging for the running and coordination of the promotion This party would usually determine and facilitate the interaction between the other parties, have the relevant cards printed and distributed and arrange for the delivery of prizes.

2. A retailer or other merchant who has one or more retail sites at which customers attend to purchase goods and/or services from the retailer. These goods are purchased at a point of sale (POS) at that site. At the time and place of sale the retailer dispenses the cards to customers based upon a purchase at the relevant site so that those customers become participants in the promotion.

3. The advertisers who wish to have their goods and/or services promoted by the promotion. These parties provide or pay for the awards. In some embodiments, other consideration is provided to the promoter by the retailer and/or the advertisers.

4. The participants are the customers of the retailers who qualify, through purchasing sufficient goods and/or services from the retailer.

A typical sequence of events involves a customer purchasing one or more goods at the POS of a given retailer who is participating in the promotion. Upon completion of a transaction, and on the basis that the quantum of that transaction exceeded a predetermined threshold, the participant is provided by the POS operator with at least one card 101. It will be appreciated that in each promotion there will be many cards and that each card is unique. In some embodiments all the cards that result in no prize being awarded are the same.

In this embodiment the retailer is a supermarket chain and the threshold is $30. However, in other embodiments different thresholds are used.

Prior to being issued with the card, the operator removes a latex panel (not shown) that covers bar code 105. This panel, when in place, is opaque and is used to assist the operator and the now participant to visually verify that the card has not been used previously. The operator then scans the bar code at the point of sale to provide an audit trail of the issue date of the card. In some embodiments, this step also activates the terminal to now accept the card, whereas previously it would not have done. In further embodiments, the scan defines the beginning of a validity period for the card to be interacted with the terminal, in that a failure to do so within a predetermined time will result in the card becoming invalid.

Although the chances of the participant being awarded a prize with card 101 are already fixed, due to the information contained within bar code 105, that will not be ascertainable from the human readable information contained on the card. That is, the participant is not aware at this point as to whether they are eligible for a prize or and, if they are so eligible, as to what that prize will be. That is the information relevant to the award of a prize is contained only in machine readable form and some further interaction is required to conclude the promotion.

To make the determination of whether a prize has been awarded the participant first must locate a terminal. In this embodiment the terminal is located adjacent to the POS so that the participant is able to quickly obtain a result.

In the event that the terminal is not being used by another participant it will be in a loop mode as the participant approaches. This loop mode includes the terminal providing advertisements associated with the advertisers such that each segment of the promotion purchased by of the advertisers gets equal weight. That is, in this embodiment there are thirty four advertisers, although six of those have each purchased two segments, which provides a total of 40 segments. The advertisements associated with each of the segments are sequentially displayed in this loop mode. There are also “free segments” for public announcements and publication of the promotion.

When at the terminal, the participant follows the instruction in region 120 and inserts card 101 into ticket receiver 4 of the terminal. The terminal, via receiver 4, obtains the promotional information and actuates an introductory sequence of coordinated images, sounds and audible emanations. This includes, in some embodiments, advertising.

As described above, the terminal is a “dumb terminal” and does not have any affect upon the result of the promotion, as that has already been determined. The use of the promotional information by the terminal is so that it will respond in accordance with any award that has been assigned to that card.

After the introductory sequence the display prompts the participant to press one of the buttons to actuate the subsequent process. Once this has occurred, the display displays a “clock image” which includes a graphical representation or icon of a plurality of goods and/or services that are designated as being awards for the promotion. These icons are located about a common pitch circle and are sequentially swept past by a hand that is rotated about the centre of the pitch circle. After the hand has completed one or two revolutions of the circle—with the intention that there is some delay, in the order of ten seconds, so as to provide a sense of excitement for the participant—it comes to rest while being orientated toward one of the icons. The icon concerned is determined from the promotional information that was obtained from card 101. This alerts the participant to the nature and extent of the prize that they have or have not, as the case may be, been awarded. While the participant has now gained a determination of the prize, he or she are still unaware as to whether or not it will be awarded. However, that determination has already been made and is included within the promotional information. It is a case that the participant is not aware of this.

The terminal then directs the participant to push the other button. Once the latter has occurred, the terminal progresses through the sequence of determining the win-lose based upon the animated sequences. The outcome of this, while perhaps unknown to the participant, is predetermined from the promotional information that has already been obtained by the terminal from bar code 105.

If the promotional information contained on card 101 initiates the terminal to display a “lose” event, the participant is encouraged to complete region 121 of card 101 and have this either sent to a postal address or placed in a receptacle at or near the terminal. This allows that participant to then enter a second chance draw.

If the promotional information contained on card 101 initiates the terminal to display a “win” event, the participant is instructed by the terminal to remove a specific one of the six latex panels that overlie regions 108 to 113. These panels are each printed with a representation of one of the animated characters to assist the participant select the relevant region. Once the relevant region is removed, the underlying surface reveals a representation of the prize that has been awarded. All that remains is for card 101 and the relevant “proof of purchase” of goods at the retail outlet, to be presented to the promoter and the corresponding prize presented to the participant.

In this embodiment, if the participant removes any of the latex panels other than that specified, card 101 will be deemed invalid.

Card 101 also includes other regions, such as region 122 that contains details of the various conditions of participation and contact details for the relevant parties.

Card 101 also includes a region 123 for containing branding information for the promoter and other instructions for the participant.

The preferred embodiments of the invention provide an incentive for customers to frequent a retail outlet and a mechanism by which the loyalty of those customers is rewarded. Another important advantage of the preferred embodiments is that they provide a entertainment for the customer and a sense of anticipation.

The preferred embodiments also allow advertisers to more specifically target their advertising and to induce subsequent purchases of a product through awarding prizes of that product. The localised nature of the advertising also allows the advertiser to gain more immediate feedback on the effectiveness of certain advertisements.

Although the invention has been described with reference to specific examples, it will be appreciated by those skilled in the art that the invention may be embodied in many other forms.

1. A method of displaying a reward selection and win-or-lose result on a game machine including a display, the method including the steps of:
(a) displaying a reward selection sequence on the display to identify a playable reward;
(b) displaying an animated win-or-lose reward shot sequence on the display to identify a win-or-lose result corresponding to the playable reward; and
(c) displaying the win-or-lose result on the display.

2. A method according to claim 1 wherein the step of displaying the animated win-or-lose reward shot sequence includes the steps of:
(b1) displaying an animated character on the display;
(b2) displaying the animated character performing a task having a goal which it may succeed or fail at achieving;
(b3) identifying the win-or-lose result as a win result if the character succeeds in achieving the goal; and
(b4) identifying the win-or-lose result as a lose result if the character fails in achieving the goal.

3. A method according to claim 2 wherein the step of displaying an animated character on the display includes the step of displaying one of six possible animated characters on the display.

4. A method according to claim 1 including a jackpot which has a corresponding jackpot prize shot sequence.

5. A method according to claim 1 wherein the animated character is one of six possible animated characters that include six respective humanoid characters having bodies resembling human bodies, voices resembling human voices and faces resembling animal faces.

6. A method according to claim 5 wherein the six possible animated characters are three generations of one family, namely an oldest generation, a middle generation and a youngest generation.

7. A method according to claim 2 wherein the animated character is rendered using computer graphics techniques.

8. A method according to claim 2 wherein the tasks are arranged into themes which determine the background and costumes of the animated characters.

9. A method according to claim 1 wherein the game machine also includes an audio sequence player and wherein the step of displaying an animated win-or-lose reward shot sequence further includes the step of simultaneously playing an audio sequence to accompany the animated win-or-lose reward shot sequence.

10. A method according to claim 9 wherein the audio sequence includes commercial music.

11. A method according to claim 1 wherein the step of displaying a reward selection sequence is preceded by the step of receiving a user-supplied reward selection request and wherein the step of displaying an animated win-or-lose reward shot sequence is preceded by the step of receiving a user-supplied win-or-lose play request.

12. A method according to claim 1 wherein the game machine includes a game initiation button and wherein the step of receiving a user-supplied reward selection request is achieved when a user presses the game initiation button.

13. A method according to claim 12 wherein the game machine includes a win-or-lose play button and wherein the step of receiving the user-supplied win-or-lose play request is achieved when a user presses the win-or-lose play button.

14. A method according to claim 13 wherein the game initiation button and the win-or-lose play button are two different buttons.

15. A method according to claim 1 wherein the game machine also includes an audio sequence player and wherein the step of receiving the user-supplied reward selection request is preceded by the step of playing an audible direction on the audio sequence player, requesting the user to provide the reward selection request.

16. A method according to claim 15 wherein the step of receiving a user-supplied win-or-lose play request is preceded by the step of playing an audible direction on the audio sequence player, requesting the user to provide the win-or-lose play request.

17. A method according to claim 1 wherein the step of displaying a reward selection sequence on the display to identify a playable reward is followed by the additional step of playing an advertisement for the playable reward on the display.

18. A method according to claim 17 wherein the step of playing the advertisement includes one or more of the following steps:
(i) displaying moving visual images on the display;
(ii) playing spoken words via the audio sequence player; and
(iii) playing music via the audio sequence player.

19. A method according to claim 18 wherein the advertisement is stored as a compressed MPEG file and wherein the step of playing the advertisement includes the step of decompressing the compressed MPEG file and playing it on the display.

20. A method according to claim 1 wherein the playable reward is one of a set of possible rewards and wherein each of the possible rewards has a corresponding reward indicia which represents the reward, and wherein the step of displaying a reward selection sequence on the display to identify the playable reward includes the steps of:
(a1) displaying a plurality of fillable shapes on the display,
(a2) displaying one or more of the reward indicia within the fillable shapes according to a predetermined selection pattern; and
(a3) displaying the indicia of the playable reward in at least one of the fillable shapes according to a predetermined win display pattern.

21. A method according to claim 20 wherein the fillable shapes are arranged in one or more rows and one or more columns on the display and wherein the predetermined selection pattern includes one or more of:
(i) sequentially filling each of the rows of fillable shapes with a particular reward indicia such that at some point all of the fillable shapes in a particular row contain that particular reward indicia;
(ii) sequentially filling each of the columns of fillable shapes with a particular reward indicia such that at some point all of the fillable shapes in a particular column contain that particular reward indicia;
(iii) filling each of the fillable shapes with different reward indicia in an apparently random fashion; or
(iv) sequentially filling each diagonal array of fillable shapes with a particular reward indicia such that at some point all of the fillable shapes in a particular diagonal array contain that particular reward indicia.

22. A method according to claim 21 wherein there are fifteen fillable shapes arranged in three rows and five columns on the display, the rows including a top row, a middle row and a bottom row, and wherein the predetermined selection pattern includes:
(i) sequentially filling the top and bottom rows of fillable shapes with a first reward indicia and a third reward indicia, respectively, in a left to right manner; and
(ii) simultaneously filling the middle row of fillable shapes with a second reward indicia, in a right to left manner;
such that at some point all of the fillable shapes in the top row contain the first reward indicia, all of the fillable shapes in the middle row contain the second reward indicia and all of the fillable shapes in the bottom row contain the third reward indicia.

23. A method according to claim 22 wherein the predetermined selection pattern is repeated a number of times.

24. A method according to claim 22 wherein the predetermined selection pattern is reversed.

25. A method according to claim 20 wherein the predetermined win display pattern includes one or more of:
(a) filling all of the fillable shapes with the playable reward indicia;
(b) filling a substantial portion of the display with an enlarged fillable shape containing the playable reward indicia;
(c) filling only one of the fillable shapes with the playable reward indicia and leaving the rest of the fillable shapes unfilled;
(d) filling an entire row of the fillable shapes with the playable reward indicia; or
(e) filling an entire column of the fillable shapes with the playable reward indicia.

26. A method according to claim 1 wherein the game machine includes a ticket dispenser for dispensing printed tickets and wherein the step of displaying the win-or-lose result on the display is followed by the further step of dispensing a printed ticket having win-or-lose result indicia printed on it.

27. A method according to claim 26 wherein the game machine includes a ticket receiver for receiving user supplied playing tickets and wherein the step of receiving a user-supplied reward selection request is preceded by the step of
(i) receiving a user supplied playing ticket via the ticket receiver;
(ii) confirming the validity of the playing ticket;
(iii) prompting the user to provide the reward selection request if the playing ticket is valid; and
(iv) displaying an invalid ticket message on the display if the playing ticket is invalid.

28. A method according to claim 27 wherein the user supplied playing ticket includes one or more of:
(i) human readable information; and
(ii) machine readable information.

29. A method according to claim 28 wherein the machine readable information includes magnetic game information stored on a magnetic strip and the human readable information includes written directions on how to play the game.

30. A method according to claim 1 wherein the game machine is situated in or near the premised of a retail outlet which sells a plurality of products or provides a plurality of services and wherein the step of receiving the user supplied playing ticket via the ticket receiver is preceded by the steps of:
(i) selling at least one of the products or services to the user; and
(ii) providing the playing ticket to the user in response to the sale.

31. A method according to claim 1 wherein the game machine further includes a controller which controls the steps taken, the controller being a single board computer.

32. A method according to claim 1 wherein the step of displaying a reward selection sequence on the display to identify the playable reward is preceded by the step of selecting the playable reward from a plurality of possible rewards.

33. A method according to claim 1 wherein the game machine stores a predetermined reward selection table storing a plurality of reward identifiers each corresponding to one of the possible rewards, along with win-or-lose indicia which indicate whether, when that reward is being played for, it will be won or lost, and wherein the step of selecting the playable reward from a plurality of possible rewards includes the steps of:
(i) incrementally stepping through the reward selection table
(ii) selecting the next reward identifiers from the reward selection table which corresponds to the current game iteration;
(iii) identifying the reward corresponding to the selected reward identifier;
(iv) making that reward the playable reward;
(iv) identifying the win-or-lose result corresponding to the selected reward identifier; and
(v) making that win-or-lose result the playable reward's corresponding win-or-lose result.

34. A method according to claim 33 wherein the reward selection table is periodically replaced or amended.

35. A method according to claim 33 wherein the reward selection table is used to predetermine the number of times each particular reward is advertised on the game machine.

36. A method according to claim 33 wherein the reward selection table is used to predetermine the number of times each particular reward is won.

37. A method according to claim 1 wherein the step of displaying the win-or-lose result on the display includes, if the win-or-lose result is a win result, the steps of:
(i) displaying video footage of a fireworks display on the display; and
(ii) intermittently superimposing over at least part of that video footage indicia corresponding to the playable reward which the user has won.

38. A method according to claim 37 further including the step of simultaneously playing an audio recording of a fireworks display via the audio sequence player.

39. A system for displaying a reward selection and win-or-lose result on a terminal, the system including:
a display for:
(a) displaying a reward selection sequence to identify a playable reward;
(b) displaying an animated win-or-lose reward shot sequence to identify a win-or-lose result corresponding to the playable reward; and
(c) displaying the win-or-lose result.

40. A machine according to claim 38 wherein the display displays the animated win-or-lose reward shot sequence by:
(b1) displaying an animated character;
(b2) displaying the animated character performing a task having a goal which it may succeed or fail at achieving;
(b3) identifying the win-or-lose result as a win result if the character succeeds in achieving the goal; and
(b4) identifying the win-or-lose result as a lose result if the character fails in achieving the goal.

41. A machine according to claim 39 wherein the animated character is rendered using computer graphics techniques.

42. A machine according to claim 38 wherein the game machine further includes an audio sequence player and wherein the audio sequence player simultaneously plays an audio sequence to accompany the animated win-or-lose reward shot sequence.

43. A machine according to claim 38 wherein the display displays the reward selection sequence after the machine receives a user-supplied reward selection request and wherein the display displays an animated win-or-lose reward shot sequence after the machine receives a user-supplied win-or-lose play request.

44. A machine according to claim 38 wherein the game machine includes a game initiation button and wherein the machine receives the user-supplied reward selection request when a user presses the game initiation button.

45. A machine according to claim 38 wherein the game machine includes a win-or-lose play button and wherein the machine receives the user-supplied win-or-lose play request when a user presses the win-or-lose play button.

46. A machine according to claim 38 wherein the game initiation button and the win-or-lose play button are two different buttons.

47. A machine according to claim 38 wherein the game machine also includes an audio sequence player and wherein the audio sequence player plays an audible direction, requesting the user to provide the reward selection request before the machine receives the user-supplied reward selection request.

48. A machine according to claim 38 wherein the audio sequence player plays an audible direction, requesting the user to provide the win-or-lose play request before the machine receives the user-supplied reward selection request.

49. A machine according to claim 38 wherein after the display displays the reward selection sequence to identify a playable reward it displays an advertisement for the playable reward.

50. A machine according to claim 48 wherein the advertisement is stored as a compressed MPEG file and wherein the machine plays the advertisement by decompressing the compressed MPEG file and playing it on the display.

51. A machine according to claim 38 wherein the predetermined win display pattern includes one or more of:
(a) filling all of the fillable shapes with the playable reward indicia;
(b) filling a substantial portion of the display with an enlarged fillable shape containing the playable reward indicia;
(c) filling only one of the fillable shapes with the playable reward indicia and leaving the rest of the fillable shapes unfilled;
(d) filling an entire row of the fillable shapes with the playable reward indicia; or
(e) filling an entire column of the fillable shapes with the playable reward indicia.

52. A machine according to claim 38 wherein the game machine includes a ticket dispenser for dispensing printed tickets and wherein after the display displays the win-or-lose result, the ticket dispenser dispenses a printed ticket having win-or-lose result indicia printed on it.

53. A machine according to claim 51 wherein the game machine further includes a ticket receiver for receiving user supplied playing tickets and wherein before the game machine receives the user-supplied reward selection request:
(i) the ticket receiver receives the user supplied playing ticket via the ticket receiver;
(ii) the machine confirms the validity of the playing ticket;
(iii) the machine prompts the user to provide the reward selection request if the playing ticket is valid; and
(iv) the display displays an invalid ticket message if the playing ticket is invalid.

54. A method for allowing a participant in a promotion to determine if he, she or it has been awarded a prize, the method including:
issuing the participant with an information carrier containing promotion information;
providing a promotion terminal having a housing, an input device mounted to the housing, and a processor mounted to the housing for driving a display;
interacting the information carrier with the input device such that the processor is provided access to the promotion information; and
driving the display with the processor, in response to the information, to inform the participant whether or not he, she or it has been awarded the prize.

55. A method according to claim 53 wherein the promotion is provided by a promoter for a retailer having at least one point of sale (POS), and the method includes the step of issuing the information carrier to the participant at the POS.

56. A method according to claim 54 wherein the information carrier is a card and the promotion information is printed on the card in machine readable form.

57. A method according to claim 55 wherein the terminal is disposed near the POS and the input device includes a card reader, the method including the step of the participant inserting the card into the reader.

58. A promotion terminal for allowing a participant in a promotion to determine if he, she or it has been awarded a prize, wherein the participant has been issued with an information carrier containing promotion information, the terminal including:
a housing;
a display mounted to the housing;
an input device mounted to the housing for interacting with the information carrier to determine the promotion information; and
a processor mounted to the housing and being responsive to the promotion information for driving the display to inform the participant whether or not he, she or it has been awarded the prize.

59. A terminal according to claim 58 wherein the promotion information includes data that is indicative of one or more of the following:
whether a prize is to be awarded to the participant;
a categorisation of the prize;
an identification number for the promotion;
a verification number for the carrier; and
a ticket number for the carrier.

60. An information carrier for issuing to a participant in a promotion, the promotion including the award of a plurality of prizes and the carrier including:
a substrate;
promotion information carried by the substrate in a first region for allowing the participant to determine if he, she or it has been awarded one of the prizes, the determination occurring through interacting the carrier with a terminal;
prize information carried by the substrate in a respective plurality of second regions for displaying the nature of corresponding prizes; and
a verification device for obscuring from view the prize information.

61. A carrier according to claim 60 wherein the promotion information is machine readable and the prize information is human viewable.

62. A carrier according to claim 60 wherein the verification device is selectively adjusted by the participant to allow viewing of the prize information contained within one or more of the respective second regions.

63. A carrier according to claim 62 wherein the terminal provides the participant with an indication as to which one or more of the second regions are to be viewed and the carrier is voided if the verification device is adjusted to allow viewing of any other of the second regions.

64. A carrier according to claim 62 wherein the promotion information contains data indicative of the second region or regions that are viewable without voiding the carrier.
